(19) United States
(12) Patent Application Publication
(10) Pub. No.: US 2026/0241724 A1
(43) Pub. Date: Aug. 20, 2026

(54) PRINTING APPARATUS AND SHEET FEEDING APPARATUS

(71) Applicant: CANON KABUSHIKI KAISHA, Tokyo (JP)

(72) Inventor: RYO KOBAYASHI, Kanagawa (JP)

(21) Appl. No.: 19/539,259

(22) Filed: Feb. 13, 2026

(30) Foreign Application Priority Data
Feb. 17, 2025 (JP) 2025-023474

(51) Int. Cl. B41J 15/04; B41J 13/00; B65H 3/06; B65H 5/06

(52) U.S. Cl. CPC B41J 15/042; B41J 13/0009; B65H 3/06; B65H 3/0684; B65H 5/062

(57) ABSTRACT

The present disclosure provides a technique capable of appropriately feeding a sheet from a roll sheet. To this end, a holding unit which rotatably holds a roll includes a pressing member that presses the outer periphery of the roll.

### BACKGROUND

### Field of Technology

The present disclosure relates to a printing apparatus for performing printing on a print medium wound in the form of a roll, and to a and sheet feeding apparatus.

### Description of the Related Art

Japanese Patent Laid-Open No. 2019-162730 discloses a printing apparatus including a temporary setting part on which to temporarily place a roll sheet having support members attached at both ends. The printing apparatus in Japanese Patent Laid-Open No. 2019-162730 is such that, after the roll sheet is temporarily placed on the temporary setting part, the temporary setting part is pivoted from an attachment-detachment position to an accommodation position to set the roll sheet on the main body of the apparatus.

Here, the printing apparatus in Japanese Patent Laid-Open No. 2019-162730 is configured such that the roll sheet set on the temporary setting part is supported at both ends. In this case, there is a possibility of winding loosening of the wound sheet. Winding loosening is specifically a phenomenon in which a sheet wound into a roll separates from the roll. This sheet separation phenomenon propagates from the outermost sheet to inner sheets. There is a possibility that feeding a sheet in a state where winding loosening has occurred may cause skew feed and, at worst, cause a jam.

### SUMMARY

In view of this, the present disclosure provides a technique capable of appropriately feeding a sheet from a roll sheet.

To this end, a printing apparatus of the present disclosure includes: a printing unit configured to perform printing on a sheet fed from a roll sheet; and a holding unit configured to move to a first position and a second position and rotatably hold the roll sheet, the first position being a position at which the roll sheet is replaceable, the second position being a position of the roll sheet in a case where the printing unit performs printing on the sheet. The holding unit has a first pressing unit configured to press an outer periphery of the roll sheet.

According to the present disclosure, it is possible to provide a technique capable of appropriately feeding a sheet from a roll sheet.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective exterior view illustrating a printing apparatus;

FIG. 2A is a schematic cross-sectional view illustrating main parts of the printing apparatus;

FIG. 2B is a schematic cross-sectional view illustrating the main parts of the printing apparatus;

FIG. 3 is a cross-sectional view illustrating a feeding apparatus with a roll at a replacement position;

FIG. 4 is a cross-sectional view illustrating a feeding apparatus with a roll at a printing position;

FIG. 5A is a view illustrating a feeding apparatus;

FIG. 5B is a view illustrating the feeding apparatus;

FIG. 5C is a view illustrating the feeding apparatus;

FIG. 6A is a view illustrating a roll pressing unit which presses a roll;

FIG. 6B is a view illustrating the roll pressing unit, which presses a roll;

FIG. 7A is a view comparing a conventional configuration and a configuration in an embodiment;

FIG. 7B is a view comparing the conventional configuration and the configuration in the embodiment;

FIG. 7C is a view comparing the conventional configuration and the configuration in the embodiment;

FIG. 7D is a view comparing the conventional configuration and the configuration in the embodiment;

FIG. 7E is a view comparing the conventional configuration and the configuration in the embodiment;

FIG. 7F is a view comparing the conventional configuration and the configuration in the embodiment;

FIG. 8 is a view illustrating a feeding apparatus in a case where the roll diameter is relatively small;

FIG. 9 is a block diagram for describing an example configuration of a control system in the printing apparatus;

FIG. 10A is a view illustrating a spindle and flanges to be attached to a roll;

FIG. 10B is a view illustrating the spindle and the flanges to be attached to a roll;

FIG. 10C is a view illustrating the spindle and the flanges to be attached to a roll;

FIG. 11A is a view illustrating the upper side of a roll setting mount;

FIG. 11B is a view illustrating the upper side of the roll setting mount;

FIG. 12A is a view illustrating a lateral side of the roll setting mount;

FIG. 12B is a view illustrating the lateral side of the roll setting mount;

FIG. 12C is a view illustrating the lateral side of the roll setting mount;

FIG. 13 is a view illustrating a feeding apparatus at a replacement position;

FIG. 14 is a view illustrating the feeding apparatus at a printing position; and

FIG. 15 is a view illustrating a sheet feeding apparatus from a Z direction.

### DESCRIPTION OF THE EMBODIMENTS

### First Embodiment

A first embodiment of the present disclosure will be described below with reference to drawings.

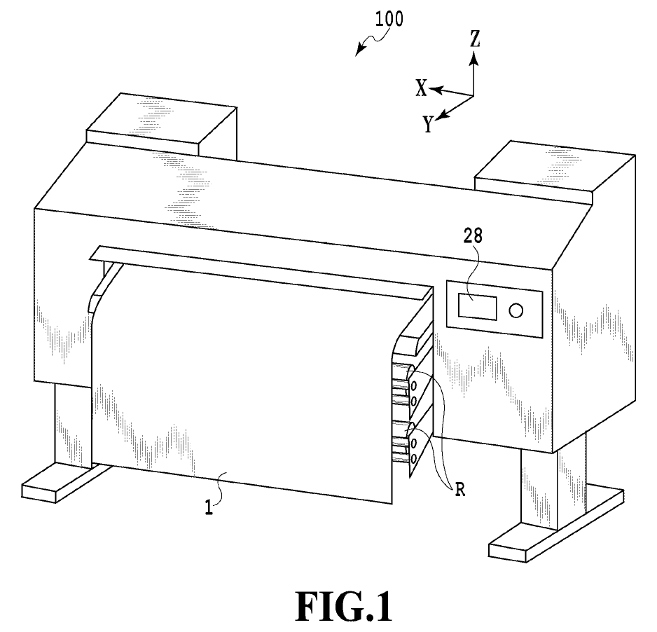

FIG. 1 is a perspective exterior view of a printing apparatus 100 to which the present embodiment is applicable. The printing apparatus 100 includes a sheet feeding unit that draws out a sheet 1 serving as a print medium from a roll R and feeds it to the main body of the apparatus, and a printing unit that performs printing on the fed sheet 1. The printing unit employs an inkjet method in which liquids are ejected onto the sheet 1 to perform printing. In the following, the sheet width direction of the roll R is an X direction, the direction of conveyance of the sheet in a printing unit 400 to be described later is a Y direction, and the direction of gravity is a Z direction (the direction of gravity is a -Z direction).

In the printing apparatus 100, a roll R obtained by winding a sheet 1 being a long continuous sheet in the form of a roll can be set at each of roll holding units at two upper and lower positions. Images are printed onto a sheet 1 drawn out selectively from one of these rolls R. By using various switches included in an operation panel 28, the user can input various commands for the printing apparatus 100, such as designation of the size of the sheet 1 and switching to an online or offline mode, and so on.

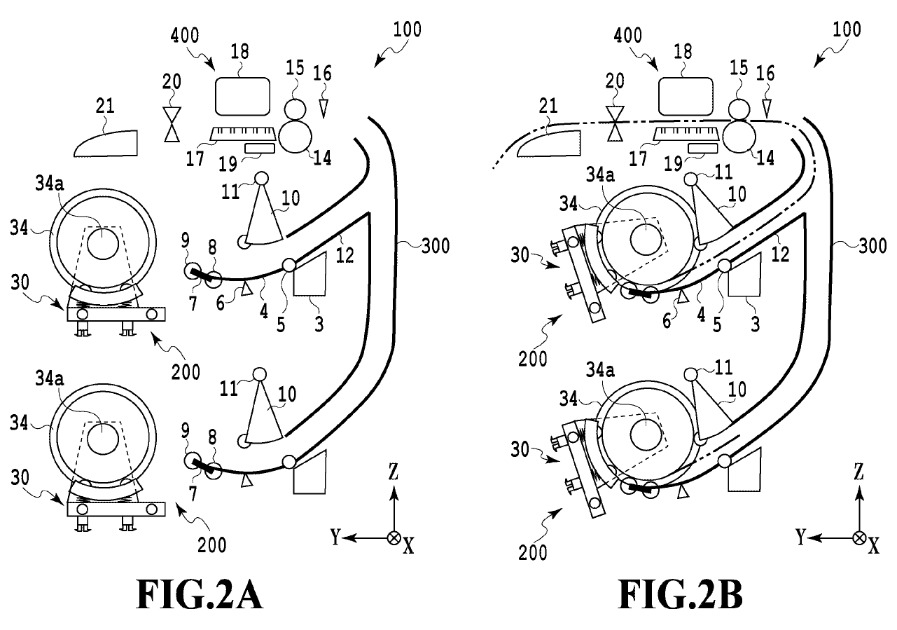

FIGS. 2A and 2B are schematic cross-sectional views illustrating main parts of the printing apparatus 100. FIG. 2A illustrates a state where the rolls R are each at a replacement position being a position at which the roll R can be replaced. FIG. 2B illustrates a state where the rolls R are each at a printing position being a position for printing. In the printing apparatus 100, two feeding apparatuses 200 for the two rolls R are disposed at upper and lower positions, respectively. A sheet 1 drawn out from either roll R by the corresponding feeding apparatus 200 is conveyed along a sheet conveyance unit 300 to the printing unit 400, which is capable of printing images. The printing unit 400 prints images onto the sheet 1 by ejecting inks from an inkjet print head 18.

Each feeding apparatus 200 includes a roll setting mount 30. The roll setting mount 30 includes roll pressing units that press the roll R. Details of the roll pressing units will be described later.

The print head 18 ejects the inks from ejection orifices using ejection energy generation elements, such as electrothermal conversion elements (heaters) or piezoelectric elements. The print head 18 is not limited only to an inkjet print head. Also, the printing method of the printing unit 400 is not limited. For example, a serial scan method, a full line method, or the like may be employed. With the serial scan method, images are printing by performing an operation of conveying the sheet 1 and scanning the print head 18 in a direction intersecting the conveyance direction of the sheet 1. With the full line method, images are printed using a long print head 18 extending in a direction intersecting the conveyance direction of the sheet 1 while continuously conveying the sheet 1.

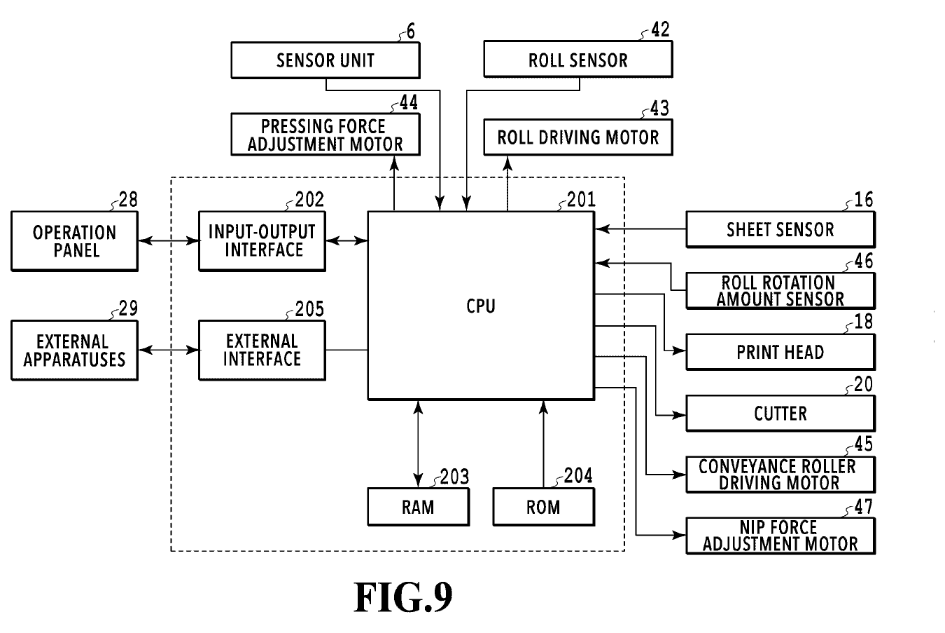

A later-described press-fitting portion 34b of a flange 34a is inserted in the roll R on an away side in the X direction, and the flange 34a is supported on a flange support portion 34. The press-fitting portion 34b is driven by a roll driving motor 43 (see FIG. 9 to be described later) to rotate forward and backward.

Each feeding apparatus 200 includes a driving unit 3, an arm member (moving body) 4, an arm rotation shaft 5, a sensor unit 6, a swing member 7, driven rotating bodies (contact bodies) 8 and 9, a separating flapper (upper guide body) 10, and a flapper rotation shaft 11. A conveyance guide 12 guides the front and back surfaces of a sheet 1 drawn out by the feeding apparatus 200 and leads that sheet 1 to the printing unit 400. A conveyance roller 14 is rotated forward and backward by a later-described conveyance roller driving motor 45 (see FIG. 9 to be described later). A nip roller 15 is capable of being driven to rotate by the rotation of the conveyance roller 14, and is capable of coming into and out of contact with the conveyance roller 14 and adjusting a nip force with a nip force adjustment motor 47 (see FIG. 9 to be described later). The speed of conveyance of the sheet 1 by the conveyance roller 14 is set to be higher than the speed at which the sheet 1 is drawn out by rotation of the roll R. This applies a back tension to the sheet 1, allowing the sheet 1 to be conveyed in a tensioned state.

A platen 17 of the printing unit 400 limits the position of the sheet 1. A cutter 20 cuts the sheet 1 on which an image has been printed. A sheet discharge base 21 supports the sheet 1 on which an image has been printed when it is discharged. Operations in the printing apparatus 100 as described above are controlled by a later-described central processing unit (CPU) 201 (see FIG. 9 to be described later).

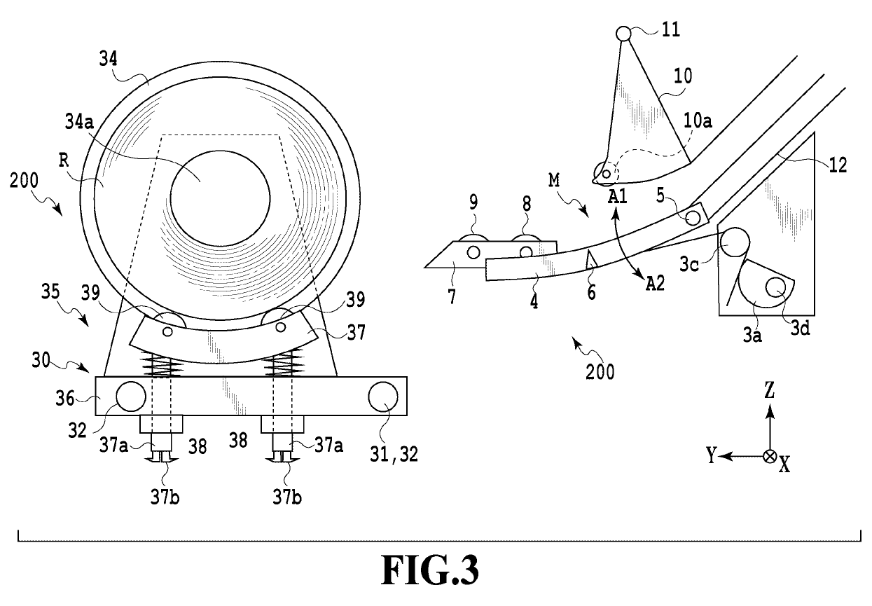

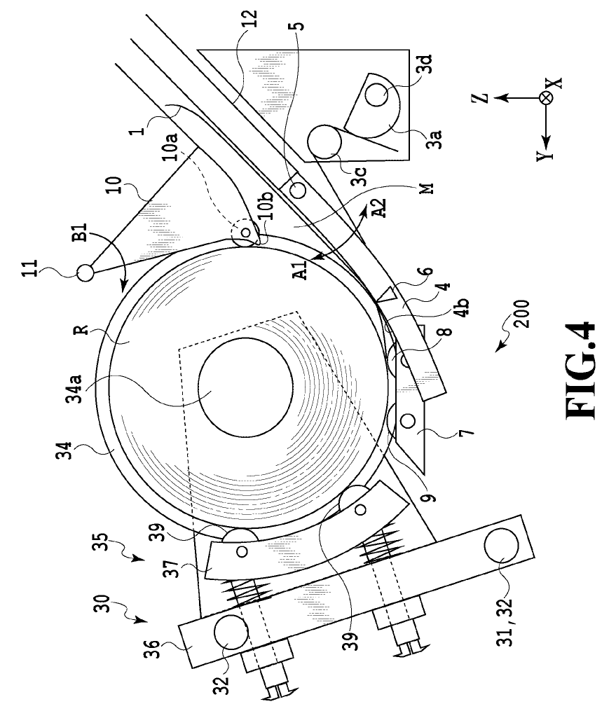

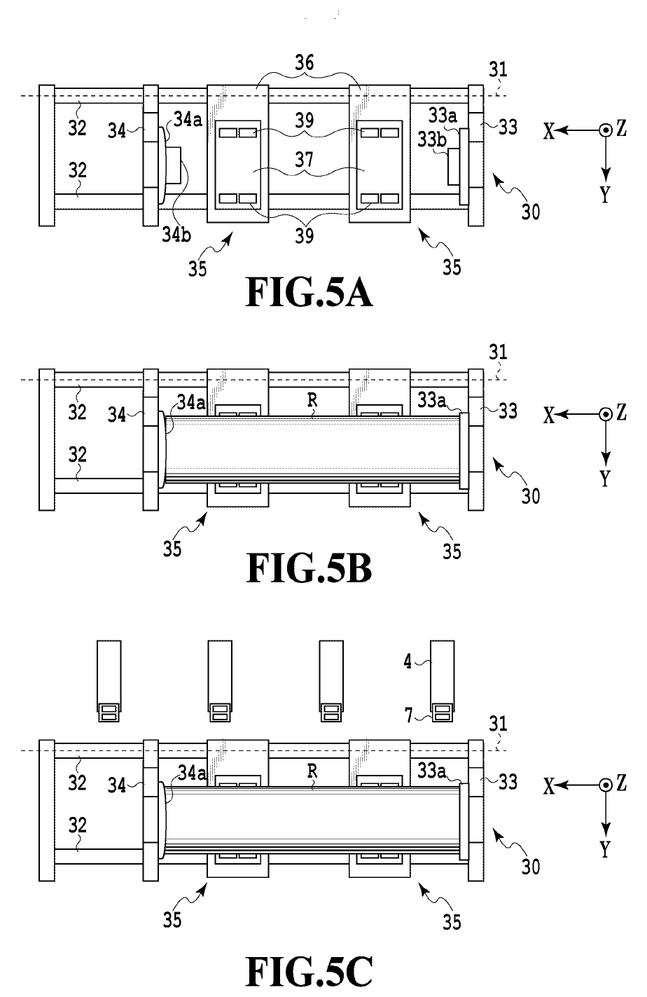

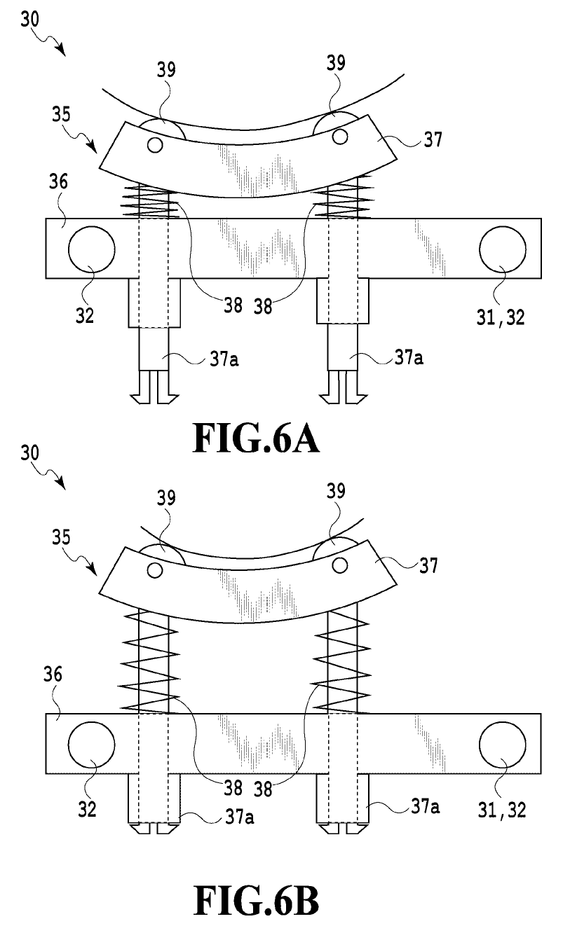

FIG. 3 is a cross-sectional view illustrating a feeding apparatus 200 with the roll R at the replacement position. FIG. 4 is a cross-sectional view illustrating the feeding apparatus 200 with the roll R at the printing position. Also, FIGS. 5A to 5C are views illustrating the feeding apparatus 200. FIGS. 6A and 6B are views illustrating a roll pressing unit 35 that presses the roll R.

The roll setting mount 30 is capable of pivoting about a rotation shaft 31 to the replacement position (see FIG. 3) and the printing position (see FIG. 4). The roll setting mount 30 is provided with two reinforcement stays 32 extending in the X direction. A flange support portion 33 is fixed to a home side of the reinforcement stays 32. In FIGS. 3 and 4, illustration of the flange support portion 33 and a flange 33a on the home side is omitted. The flange 33a is attached to the home-side flange support portion 33 in such a manner as to be capable of being rotationally driven by the later-described roll driving motor 43. The away-side flange support portion 34 is provided on the reinforcement stays 32 in such a manner as to be movable in the X direction, and the away-side flange 34a is attached to the flange support portion 34 in such a manner as to be rotatable.

The reason for this is that the conveyance of the sheet 1 in the printing on the sheet 1 is based on the home side and also that the position of the away-side flange 34a varies depending on the size of the paper to be used. The home-side flange 33a is provided integrally with a press-fitting portion 33b to be press-fitted into a paper tube in the roll R. The away-side flange 34a is provided integrally with the press-fitting portion 34b to be press-fitted into the paper tube in the roll R.

In the present embodiment, multiple roll pressing units 35 are provided between the home-side flange 33a and the away-side flange 34a in such a manner as to be movable along the reinforcement stays 32. The roll pressing units 35 are configured to be capable of pressing the outer periphery of the roll R, and are movable to any positions according to the width of the roll R to be fed. Each roll pressing unit 35 in the present embodiment includes a base member 36 and a pressing member 37. Each pressing member 37 is provided with movement restriction portions 37a at four positions. An elastically deformable hooked portion 37b is provided at the tip of each movement restriction portion 37a. In the pressing member 37, holes to insert the movement restriction portions 37a are bored. By inserting the movement restriction portions 37a to the bottoms of the holes while letting the hooked portions 37b deform, the hooked portions 37b will serve as retainers.

In the present embodiment, the base members 36 are in a horizontal posture in a state where the feeding apparatus 200 is at the replacement position as illustrated in FIG. 3, and the base members 36 are tilted from the horizontal posture in such a way as to cover the roll R in a state where the feeding apparatus 200 is at the printing position as illustrated in FIG. 4.

This configuration allows the roll pressing units 35 to move while maintaining such a posture as to press the roll R. Also, as illustrated in FIGS. 6A and 6B, springs 38 are sandwiched between each pressing member 37 and the corresponding base member 36, and the pressing member 37 is pressed against the roll R by the springs 38. FIG. 6A illustrates a state where the sheet 1 of the roll R is wound a relatively large number of times (the diameter of the roll R is large). FIG. 6B illustrates a state where the sheet 1 of the roll R is wound a relatively small number of times (the diameter of the roll R is small). The pressing member 37 is provided with pressing rollers 39 at positions an equal distance from the center of the roll R, which are capable of rotating in such a direction as to reduce the sliding resistance between the pressing member 37 and the roll R when the roll R is rotated. Also, the pressing member 37 has a circular arc shape extending along the outer periphery of the roll R. This is to prevent the roll R with a reduced diameter from contacting the pressing member 37 in a case of supporting that roll R at two points with the pressing rollers 39. For this reason, the arrangement of the pressing rollers 39 and the radius of the circular arc shape of the pressing member 37 are desirably determined to satisfy such a relationship that no interference occurs even in a state where the roll diameter of the roll R is smallest. Note that, instead of a circular arc shape, the pressing member 37 may have, for example, a V-shaped configuration to avoid interference with the roll.

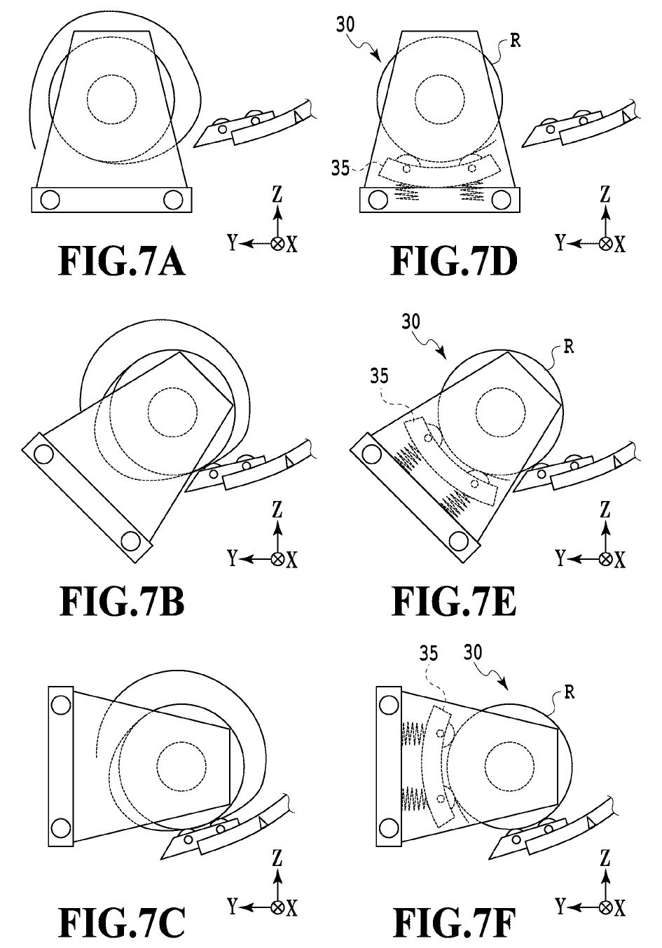

FIGS. 7A to 7C are views illustrating a process of setting a roll with a conventional configuration without the roll pressing unit 35. FIGS. 7D to 7F are views illustrating a process of setting a roll in the present embodiment.

In the conventional configuration (see FIGS. 7A to 7C), which does not include the roll pressing units that press the outer periphery of a roll, the roll sheet at the replacement position exerts such a force as to return to a flat state from the wound state, causing winding loosening. Further, the winding loosening progresses while the roll is moved to the printing position due to the vibration resulting from the movement, and the winding loosening stops as the roll comes into contact with the two driven rotating bodies at the printing position. However, in the state where the roll is set at the printing position, winding loosening has already occurred. Hence, there is a possibility that feeding the sheet in this state may result in skew feed and, at worst, cause a jam, making it impossible to feed the sheet.

With the configuration in the present embodiment (see FIGS. 7D to 7F), the roll pressing units press the outer periphery of the roll R in all states including the state where the roll R is at the replacement position, during the movement from the replacement position to the printing position, and the state where the roll R is at the printing position. For this reason, winding loosening does not occur in any of the states. This makes it possible to appropriately feed a sheet from the roll sheet.

A method of setting the roll R will be described below. First, the roll setting mount 30 is pivoted to the replacement position, the roll pressing units 35 are moved to any positions (see FIG. 5A), and then the roll R is placed on the roll pressing units 35 in a state without winding loosening. Thereafter, while the roll R is lifted up with the hands, the press-fitting portion 33b of the home-side flange 33a is inserted into the paper tube of the roll R, and further the away-side flange 34a is moved to insert the press-fitting portion 34b (see FIG. 5B). At this time, the roll R is in a state of being supported by the flanges at both ends. Thus, without no means, winding loosening the roll R will occur. In the present embodiment, however, the roll pressing units 35 are pressing and supporting the roll R from below. Hence, winding loosening of the roll R will not occur.

After the press-fitting portions 33b and 34b are inserted, the reinforcement stays 32 are held to pivot the roll setting mount 30 about the rotation shaft 31. As a result, the roll R is set at the printing position. During this pivoting operation, the roll pressing units 35 remain pressing the outer periphery of the roll R, thus preventing winding loosening of the roll R. The arm member (moving body) 4 and the swing member 7 are in such a positional relationship as not to interfere with each other in the Y direction. Thus, they may be arranged at any positions in the X direction relative to each other (see FIG. 5C).

At the printing position illustrated in FIG. 4, the roll pressing units 35 remain pressing the roll R. Nonetheless, since the pressing rollers 39 are in contact with the roll R, the sliding resistance is low. Hence, the effect of the pressing on the sheet feed and the printing is significantly low. The printing position is the final position of the roll R for printing, and the printing starts with the roll R at the printing position. Note that, in a case where the driven rotating bodies (contact bodies) 8 and 9 are pressed against the roll by the arm member (moving body) 4 at the printing position, preventing winding loosening, the roll pressing units 35 may be configured to be separated from the roll R at the printing position. That is, the roll pressing units 35 may be configured be capable of releasing the pressing on the outer periphery of the roll R after the driven rotating bodies 8 and 9 start pressing the roll R.

Next, a configuration to feed the roll R to the printing unit 400 (see FIGS. 2A and 2B) will be described. With the rotation shaft 5, the arm member (moving body) 4 is attached to the conveyance guide 12 (see FIG. 3) in such a way as to be rotatable in the directions of arrows A1 and A2. A torsion coil spring 3c that presses the arm member 4 in the direction of arrow A1 is interposed between the arm member 4 and a rotating cam 3a of the driving unit 3. The rotating cam 3a is rotated by the later-described pressure adjustment motor 43 (see FIG. 9 to be described later), and changes the force with which the torsion coil spring 3c presses the arm member 4 in the direction of arrow A1 according to its rotational position.

As will be described later, in a case of setting the leading edge of the sheet 1 into a sheet feed port M between the arm member 4 and the separating flapper 10, the pressing force on the arm member 4 from the torsion coil spring 3c is switched to one of four levels based on the rotational position of the rotating cam 3a. The pressing force of the arm member 4 can be switched among a pressing state with a relatively small force (a pressing force to apply a weak nip), a pressing state with a relatively large force (a pressing force to apply a strong nip), a pressing state with a force between the weak nip and the strong nip (a pressing force to apply a moderate nip), and a state of releasing the pressing force. In the present embodiment, four levels of pressing force are used, but the number of levels is not limited to four. Also, a configuration to perform stepless adjustment may be employed.

The swing member 7 is swingably attached to the arm member 4. The first and second driven rotating bodies (rotating bodies) 8 and 9, which are located to be offset from each other in the circumferential direction of the roll R, are rotatably attached to that swing member 7. The driven rotating bodies 8 and 9 are brought into pressure contact with the outer periphery of the roll R from below in the direction of gravity by the pressing force applied to the arm member 4 in the direction of arrow A1. Specifically, the driven rotating bodies 8 and 9 are brought into pressure contact with the outer periphery of the roll R from the lower side of the roll R in the direction of gravity. The force of that pressure contact is changed according to the pressing force with which the arm member 4 is pressed in the direction of arrow A1.

In the printing apparatus 100, the separating flapper 10 located above the arm member 4 is mounted in such a way as to be rotatable in the directions of arrows B1 and B2 (see FIG. 4) about the rotation shaft 11. The separating flapper 10 is configured to come into abutment with and press the outer peripheral surface of the roll R under its own weight. In a case where it is necessary to more strongly press the roll R, a biasing force from a biasing member, such as a spring, may be used. At the portion of the separating flapper 10 that contacts the roll R, a driven roller 10a is rotatably provided in order to reduce the effect of the pressing force on the sheet 1. Also, a separating portion 10b at the tip of the separating flapper 10 is formed to extend as close as possible to the surface of the roll R in order to make it easy to separate the leading edge of the sheet from the roll R.

The sheet 1 is passed over the driven rotating bodies 8 and 9 and drawn out from the roll R. The lower surface of the sheet 1 is guided by a guide portion 4b on the upper side of the arm member 4. The sheet 1 is then fed through a feed path from the sheet feed port M between the separating flapper 10 and the arm member 4. As described above, the driven rotating bodies 8 and 9 are brought into pressure contact with the outer periphery of the roll R, and the guide portion 4b guides the lower surface of the sheet 1 passed over the driven rotating bodies 8 and 9 and drawn out. In this way, the sheet 1 is smoothly fed using the weight of the sheet 1. Also, the driven rotating bodies 8 and 9 and the guide portion 4b are moved according to the roll outer diameter of the roll R. In this way, the sheet 1 is reliably drawn out from the roll R and conveyed regardless of the outer diameter of the roll R.

The printing apparatus 100 has a function to automatically load the sheet 1 (automatic sheet feeding function). In the automatic loading, in a case where the user sets an unused roll R on the printing apparatus 100, the apparatus rotates the roll R in the reverse direction to the direction for sheet feed and detects the leading edge of the sheet. Then, the printing apparatus 100 rotates the roll R in the rotational direction for sheet feed and automatically feeds the leading edge of the sheet separated from the roll R. The sensor unit 6 detects that the leading edge of the sheet 1 has been detached from the outer peripheral surface of the roll R, or sheet detachment (sheet separation). The leading edge of the sheet 1 detected by the sensor unit 6 is automatically inserted into the sheet feed port between the arm member 4 and the separating flapper 10 and fed.

During the detection of the leading edge of the sheet 1 with the roll R rotated in the reverse direction to the direction for sheet feed, the periodic angle required for the leading edge of the roll R to make one complete revolution will exceed 360 degrees if the roll R is loosened, as with the conventional configuration. This may result in a failure to correctly determine the position of the leading edge and insert the leading edge of the sheet into the sheet feed port, causing a jam. The period of the leading edge is checked while the roll R is rotated in the opposite direction and, in a case where the period decreases to the range of 360±3 degrees, it is determined that the winding loosening has now been resolved, and the roll R is rotated in the direction for paper feed. In a case where the period does not decrease to the range of 360±3 degrees, it is necessary to repeat the rotation in the reverse direction and continue to the rotation until the winding loosening is resolved. As described above, in a case where winding loosening has occurred when the roll R is set at the printing position, a retry operation or operations must be performed to resolve the winding loosening. This will make the paper feed time long. Further, this problem worsens for media with high stiffness.

In the present embodiment, the roll pressing units 35 constantly press the outer periphery of the roll R from the replacement position to the printing position, thereby preventing winding loosening of the roll R and also shortening the time required to feed paper with the automatic loading function. Also, in the present embodiment, two upper and lower feeding apparatuses 200 are included. This makes it possible to switch from a state where one feeding apparatus 200 is feeding a sheet 1 to a state where the other feeding apparatus 200 feeds a sheet 1. In such a case, the one feeding apparatus 200 winds the sheet 1 fed up to that point back to the roll R. At this time, the sheet 1 is rewound until the leading edge of the rewound sheet 1 reaches a position where the leading edge can be detected by the sensor unit 6.

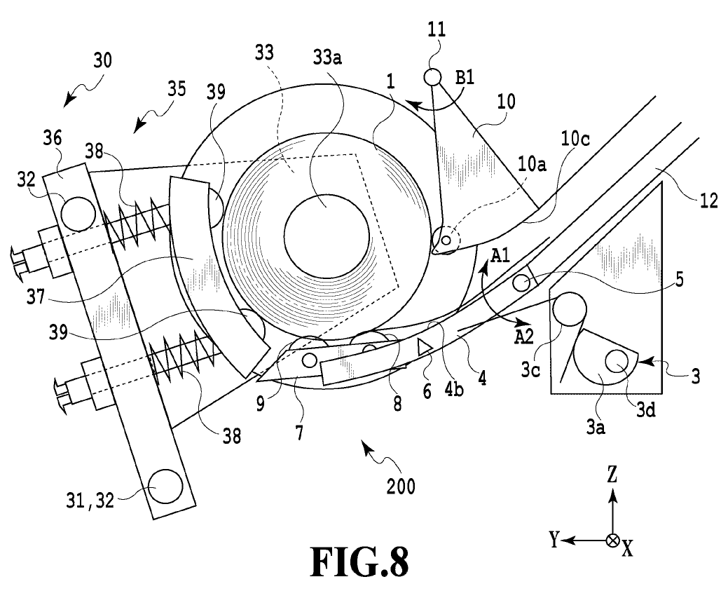

FIG. 8 is a view illustrating a feeding apparatus 200 in a case where the diameter of the roll R is relatively small. The pressing members 37, which are movable in the radial direction of the roll R by the springs 38 and press the outer periphery of the roll R, are capable of pressing the roll R even in a case where it is small. The arm member 4, which is pressed in the direction of arrow A1 by the torsion coil spring 3c, pivots in the direction of arrow A1 according to the decrease in the outer diameter of the roll R. Also, by rotating the rotating cam 3 according to the change in the outer diameter of the roll R, the pressing force on the arm member 4 from the torsion coil spring 3c can be maintained within a predetermined range regardless of the change in the outer diameter of the roll R.

Also, the separating flapper 10, which is pressed in the direction of arrow B1, pivots in the direction of arrow B1 according to the decrease in the outer diameter of the roll R. In this way, even in a case where the outer diameter of the roll R becomes small, the separating flapper 10 forms a feed path between itself and the conveyance guide 12 and guides the upper surface of the sheet 1 with a lower surface 10c. As described above, the arm member 4 and the separating flapper 10 pivot according to the change in the outer diameter of the roll R, so that a feed path of a substantially constant size is formed between them regardless of the outer diameter of the roll R.

FIG. 9 is a block diagram for describing an example configuration of a control system in the printing apparatus 100. The CPU 201 of the printing apparatus 100 controls components of the printing apparatus 100, including the feeding apparatuses 200, the sheet conveyance unit 300, and the printing unit 400, in accordance with a control program stored in a read-only memory (ROM) 204. The CPU 201 receives the type and width of each sheet 1, various pieces of setting information, and the like from the operation panel 28 through an input-output interface 202. Also, the CPU 201 is connected to various external apparatuses 29 including a host apparatus, such as a personal computer, through an external interface 205, and sends and receives various pieces of information, such as print data, to and from the external apparatuses 29. Also, the CPU 201 writes and reads out information on the sheet 1 to and from a random-access memory (RAM) 203. The motor 43 is a roll driving motor for rotating the roll R forward and backward through the home-side flange 33a (see FIGS. 5A, 5B, and 5C), and forms a driving mechanism (rotation mechanism) capable of rotationally driving the roll R. A pressing force adjustment motor 44 is a motor that rotates the rotating cam 3a to adjust the pressing force to be applied to the arm member 4. A conveyance roller driving motor 45 is a motor for rotating the conveyance roller 14 forward and backward. A roll sensor 42 is a sensor for detecting that the roll setting mount 30 is set at the printing position. A roll rotation amount sensor 46 is a sensor for detecting the amount of rotation of the roll R and is, for example, a rotary sensor that outputs a number of pulses corresponding to the amount of rotation of the roll R.

Note that, in the present embodiment, a configuration in which each feeding apparatus 200 includes a roll setting mount 30 has been described, but the present disclosure is not limited to this. The configuration may be such that connectable sheet feeding apparatuses each including a roll setting mount 30 may be provided separate from the printing apparatus 100, and the sheet feeding apparatuses and the printing apparatus 100 are connected in a case of feeding roll paper to the printing apparatus 100.

As described above, the holding units, each of which rotatably holds a roll R, include pressing members that press the outer periphery of the roll R. This makes it possible to provide a technique capable of appropriately feeding a sheet from a roll sheet.

### Second Embodiment

A second embodiment of the present disclosure will be described below with reference to drawings. Note that the basic configuration in the present embodiment is similar to that in the first embodiment, and the characteristic configuration will therefore be described below. In the present embodiment, a configuration in which each roll R includes a spindle 50 will be described.

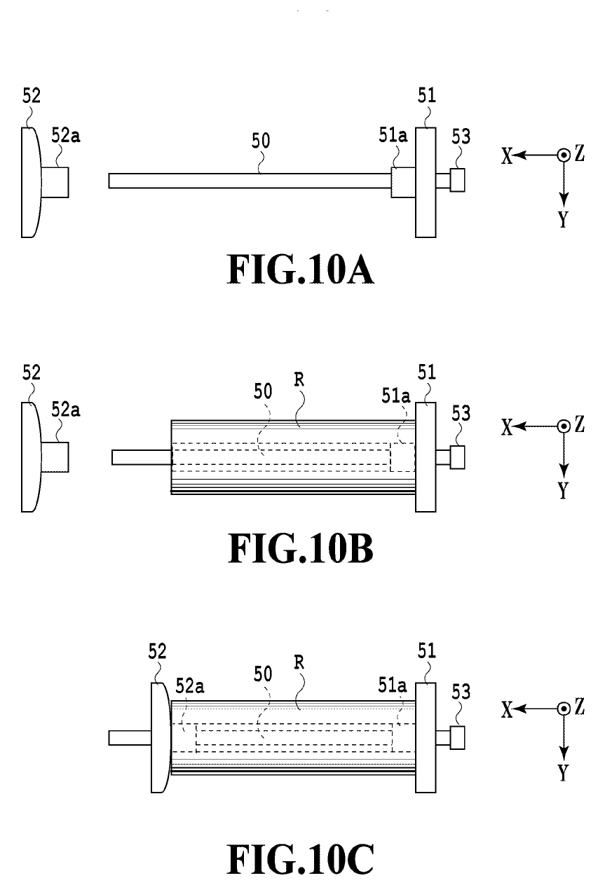

FIGS. 10A to 10C are views illustrating a roll R and a spindle 50 and flanges to be attached to the roll R in the present embodiment. The spindle 50 is formed by aluminum extrusion or the like. A home-side flange 51 is fixed to the spindle 50. An away-side flange 52, on the other hand, is configured to be fixable according to the roll width.

The home-side flange 51 is provided with a press-fitting portion 51a formed integrally with the home side 51. The away-side flange 52 is provided with a press-fitting portion 52a formed integrally with the away-side flange 52. The press-fitting portions 51a and 52a are to be inserted into the paper tube of the roll R. An end gear 53 is provided at the end of the spindle 50 on the home side, and is configured to be capable of rotating the roll R by meshing with a gear drive train coupled to a motor in a case where the spindle 50 is set on the main body of the apparatus.

A method of mounting a roll sheet will now be described. To mount a roll sheet, first, the away-side flange 52 is detached from the spindle 50 (FIG. 10A), and the press-fitting portion 51a of the home-side flange 51 is inserted into the paper tube of the roll R (FIG. 10B). Thereafter, the away-side flange 52 is fitted on the spindle 50 to insert the press-fitting portion 52a into the paper tube of the roll R. This completes the attachment of the flanges to the roll R.

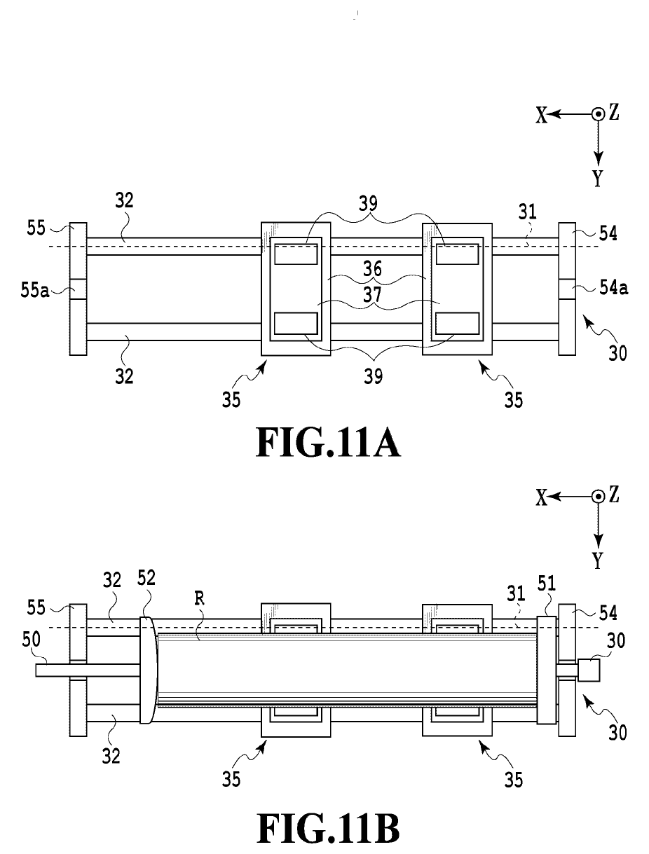

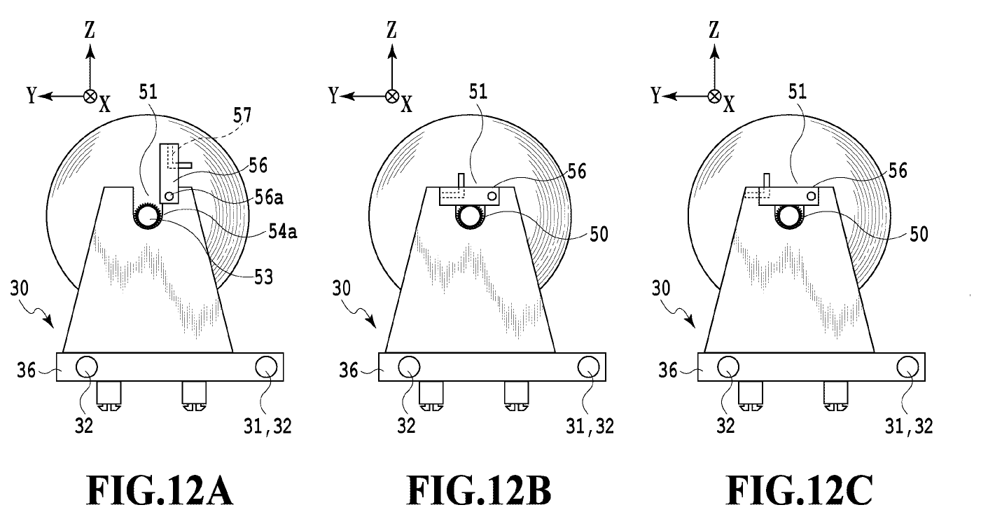

FIGS. 11A and FIG. 11B are views illustrating the upper side of the roll setting mount 30 in the present embodiment. FIGS. 12A to 12C are views illustrating a lateral side of the roll setting mount 30. The roll setting mount 30 in the present embodiment is such that a home-side spindle receiver 54 and an away-side spindle receiver 55 are fixed to the home side and away side of the two reinforcement stays 32 extending in the X direction, respectively. The home-side spindle receiver 54 and the away-side spindle receiver 55 respectively include U-shaped bearing portions 54a and 55a (see FIGS. 11A and 12A) that receive the spindle 50. The spindle 50 on which the roll R is set is set in the bearing portions 54a and 55a. This determines the positions in the X and Y directions. Also, a restriction part (restriction member) 56 that restricts movement in the Z direction is pivotable about a rotation shaft 56a, and includes a lock lever 57.

As illustrated in FIG. 12A, in a case of setting the spindle 50, the Z-direction restriction part 56 is opened (see FIG. 12A). After the spindle 50 is set, the Z-direction restriction part 56 is pivoted to be closed (see FIG. 12B). Then, the Z-direction restriction part is fixed by pulling the lock lever 57. The configuration of the restriction part 56 and the lock lever 57 described above is similar on the away side as well. The subsequent procedure is the same as that in the first embodiment. The configuration with the spindle in the present embodiment can similarly prevent winding loosening of the roll paper.

Thus, the present disclosure is applicable to a configuration with a spindle. This makes it possible to appropriately feed a sheet from a roll sheet.

### Third Embodiment

A third embodiment of the present disclosure will be described below with reference to drawings. Note that the basic configuration in the present embodiment is similar to that in the first embodiment, and the characteristic configuration will therefore be described below. In the first embodiment, a configuration in which the roll setting mount 30 is pivotable to the replacement position and the printing position has been described. In the present embodiment, a configuration in which the roll setting mount 30 is moved using rails and the like will be described.

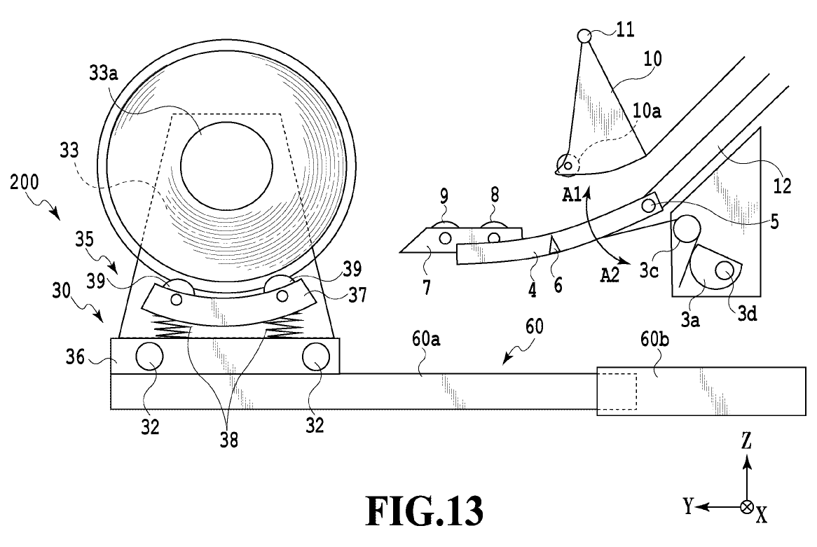

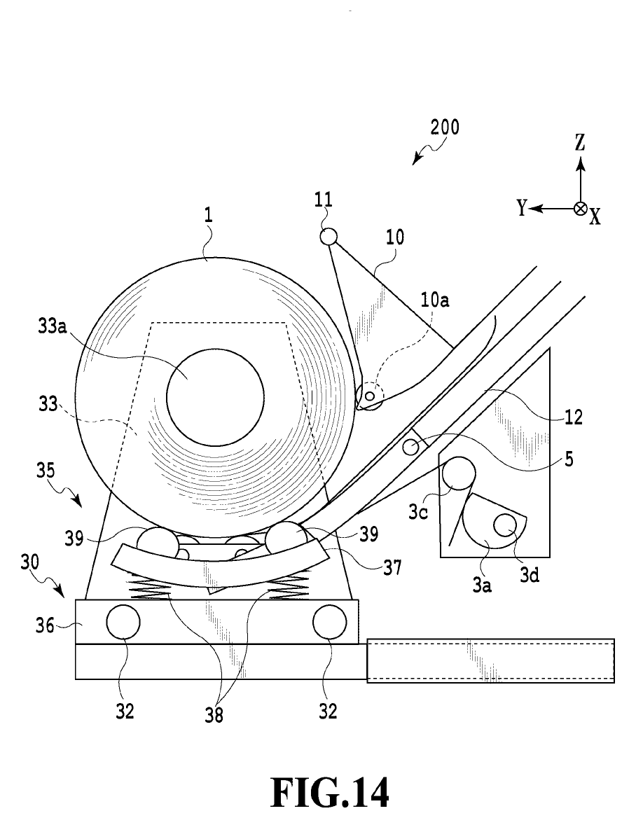

FIG. 13 is a view illustrating a view illustrating a feed device 200 at the replacement position in the present embodiment. FIG. 14 is a view illustrating the feeding apparatus 200 at the printing position. Each feeding apparatus 200 in the present embodiment includes extensible rails 60. Each extensible rail 60 includes an extensible portion 60a and a fixed portion 60b. The extensible portion 60a is slid into the fixed portion 60b to be accommodated therein. This makes the extensible portion 60a extensible and retractable. The extensible rails 60 are formed at two positions on the home side and away side of the printing apparatus 100. The fixed portion 60b is fixed to the housing of the printing apparatus 100. The roll setting mount 30 described in the first embodiment is fixed to the tip of the extensible portion. The configuration of the roll setting mount 30 is similar to that in the first embodiment.

In a case where the user holds the reinforcement stays 32 and moves the roll setting mount 30 in the ±Y direction, the roll setting mount 30 can be linearly moved in a sliding manner between the replacement position and the printing position. In FIG. 13, each extensible portion 60a is in a fully extended state and is at the replacement position. FIG. 14 is a view illustrating a state where the roll setting mount 30 has been moved to the printing position. As illustrated in FIG. 13, the swing member 7 fixed to the arm member 4 is at a position where it would interfere with the roll R at the printing position. Here, the swing member 7 is configured to be swingable, and the roll R and the swing member 7 fixed to the arm member 4 come into contact with each other as the roll R is moved from the replacement position to the printing position. As a result, the torsion coil spring 3c gets displaced such that the swing member 7 is moved and retracted in the -Z direction. Hence, interference does not occur.

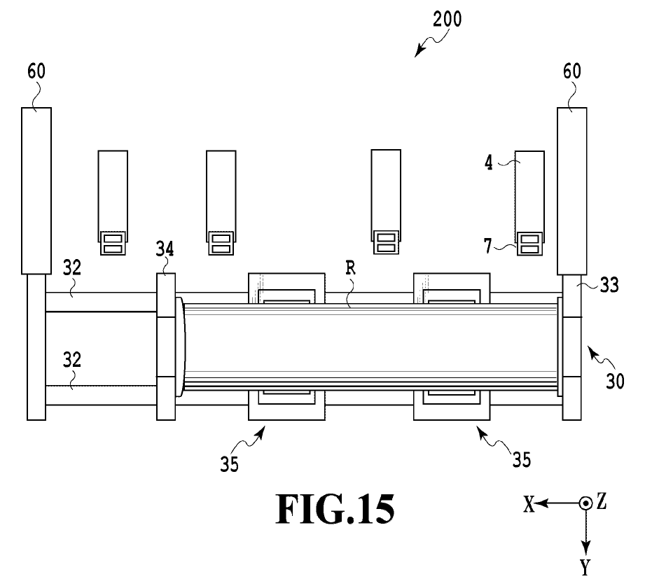

FIG. 15 is a view illustrating the sheet feeding apparatus 200 from the Z direction. The roll pressing units 35 and the swing member 7 fixed to the arm member 4 are disposed at such positions as not to interfere with each other in the X direction.

As described above, the configuration is such that the feeding apparatus 200 includes the extensible rails 60, and the roll setting mount 30 can be moved to the replacement position and the printing position via extension and retraction of the extensible rails 60. Such a configuration also makes it possible to appropriately feed a sheet from a roll sheet.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023474, filed February 17, 2025, which is hereby incorporated by reference herein in its entirety.

What is claimed is:

1. A printing apparatus comprising:
a printing unit configured to perform printing on a sheet fed from a roll sheet; and
a holding unit configured to move to a first position and a second position and rotatably hold the roll sheet, the first position being a position at which the roll sheet is replaceable, the second position being a position of the roll sheet in a case where the printing unit performs printing on the sheet, wherein
the holding unit has a first pressing unit configured to press an outer periphery of the roll sheet.

2. The printing apparatus according to claim 1, wherein the first pressing unit is capable of pressing the outer periphery of the roll sheet at the first position, between the first position and the second position, and at the second position.

3. The printing apparatus according to claim 1, wherein the first pressing unit is capable of releasing the pressing on the outer periphery of the roll sheet at the second position.

4. The printing apparatus according to claim 3, further comprising a second pressing unit configured to press the outer periphery of the roll sheet in a state where the roll sheet is at the second position.

5. The printing apparatus according to claim 4, wherein the pressing on the outer periphery of the roll sheet by the first pressing unit is released after the second pressing unit starts pressing the outer periphery of the roll sheet.

6. The printing apparatus according to claim 1, wherein the holding unit moves from the first position to the second position by pivoting.

7. The printing apparatus according to claim 1, wherein the holding unit moves from the first position to the second position by linearly sliding.

8. The printing apparatus according to claim 1, wherein the first pressing unit includes a pressing roller, and the pressing roller presses the outer periphery of the roll sheet.

9. The printing apparatus according to claim 1, wherein the holding unit holds a roll sheet including a spindle, and holds the roll sheet with the spindle set in a U-shaped bearing portion.

10. The printing apparatus according to claim 9, wherein the holding unit has a restriction member configured to restrict movement of the spindle set in the bearing portion, and the restriction member is pivotable.

11. The printing apparatus according to claim 4, wherein the second pressing unit is configured to be swingable.

12. The printing apparatus according to claim 4, wherein
the printing apparatus comprises a plurality of the first pressing units and a plurality of the second pressing units, and
the plurality of first pressing units and the plurality of second pressing units are provided as such positions as not to interfere with each other at the second position.

13. A sheet feeding apparatus
being connectable to an apparatus to which to fed a sheet drawn out from a roll sheet, and
comprising a holding unit configured to be capable of moving to a first position and a second position and to rotatably hold the roll sheet, the first position being a position at which the roll sheet is replaceable, the second position being a position at which the sheet is fed to the apparatus, wherein
the holding unit includes a pressing unit configured to press an outer periphery of the roll sheet.
